(19) United States
(12) Patent Application Publication
(10) Pub. No.: US 2007/0071562 A1
(43) Pub. Date: Mar. 29, 2007

(54) Drill motor assembly for drilling out rivets

(76) Inventor: Max W.A. Spitznagel, Los Angeles, CA (US)

Correspondence Address: LAWRENCE N. GINSBERG, 21 SAN ANTONIO, NEWPORT BEACH, CA, 92660-9112, US

(21) Appl. No.: 11/233,769

(22) Filed: Sep. 23, 2005

(51) Int. Cl. B23B 49/00

(52) U.S. Cl. 408/84

(57) ABSTRACT

A drill motor assembly for drilling out rivets includes an attachment assembly having a centering guide that is positioned about the outer circumferential edge of a rivet so as to center an attached drill bit relative to the rivet. A guide element of the attachment assembly is axially translatable relative to a housing/guide support of a drill assembly of the drill motor assembly.

### BACKGROUND OF THE INVENTION

1. Field of the Invention

The present invention relates to drill motor assemblies and more particularly to a drill motor assembly that includes an attachment assembly for precisely centering a drill bit relative to the center of a rivet to be removed.

2. Description of the Related Art

Newly developed aluminum bodied automobiles use a self-piercing rivet (i.e. no hole has been pre-drilled for rivet installation). Some newly developed steel-bodied automobiles also use such self-piercing rivets. In order to replace a body panel the rivet is required to be removed. Presently, a stud is welded onto the rivet and the rivet pulled out. This is very expensive and very time consuming. The rivet is typically 42 RC hardened. It is therefore, very difficult to center punch the rivet. Further, conventional drills are not suited for drilling these rivets because the drill wears quickly.

It is therefore desired to have a drill motor assembly that automatically centers the drill bit and to have the proper rpm for a commensurate drill size.

### SUMMARY OF THE INVENTION

In a broad aspect, the present invention is a drill motor assembly for drilling out rivets. The drill motor assembly includes a drill assembly and an attachment assembly. The drill assembly includes a drill assembly housing, including a housing/guide support. The drill assembly further includes a motor output shaft. The housing/guide support and the motor output shaft are each located at a distal end portion of the drill assembly housing. The housing/guide support includes a threaded portion and a guide portion thereon. The attachment assembly includes a retainer having a proximal end secured to the threaded portion of the housing/guide support and a securing lip at a distal end thereof. A guide element includes a guide element proximal portion positioned about an outer surface of the housing/guide support for slideable engagement thereto. The guide element proximal portion includes a radially outward extending guide element stop. A guide element distal portion includes an opening for changing drill bits and for evacuation of rivet chips; and, a centering guide attachment portion on the distal end thereof. A centering guide is attachable to the centering guide attachment portion, the centering guide having a tip for engagement on an outer circumferential edge of a rivet to be removed. A spring is positioned between the guide element proximal portion and the retainer. The spring is for urging the guide element stop against the securing lip of the retainer. A drill attachment shaft has a proximal end securely attached to the motor output shaft and a distal end for receiving and securely attaching a drill bit. A bearing supports the drill attachment shaft relative to the housing/guide support. During use, the centering guide is positioned about the outer circumferential edge of a rivet so as to center an attached drill bit relative to the rivet, the guide element being axially translatable relative to the housing/guide support.

### BRIEF DESCRIPTION OF THE DRAWINGS

FIG. 1 is a right side perspective view of the drill motor assembly of the present invention.

FIG. 2 is a cross-sectional view of the attachment assembly the drill motor assembly of FIG. 1, prior to engagement with a rivet.

FIG. 3 is a cross-sectional view of the attachment assembly the drill motor assembly of FIG. 1, with the guide element fully retracted representing engagement with a rivet.

FIG. 4 are cross-sectional views showing a) conventional removal of a countersunk self-piercing rivet; b) removal of a countersunk self-piercing rivet in accordance with the principles of the present invention; c) and, removal of a dome type rivet in accordance with the principles of the present invention.

The same elements or parts throughout the figures of the drawings are designated by the same reference characters.

### DETAILED DESCRIPTION OF THE INVENTION

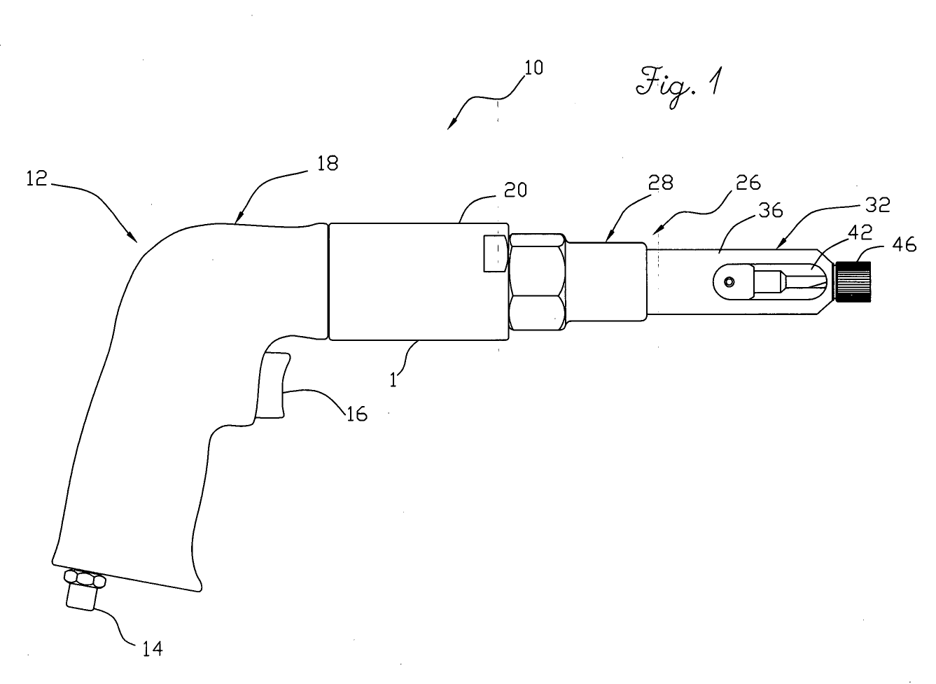

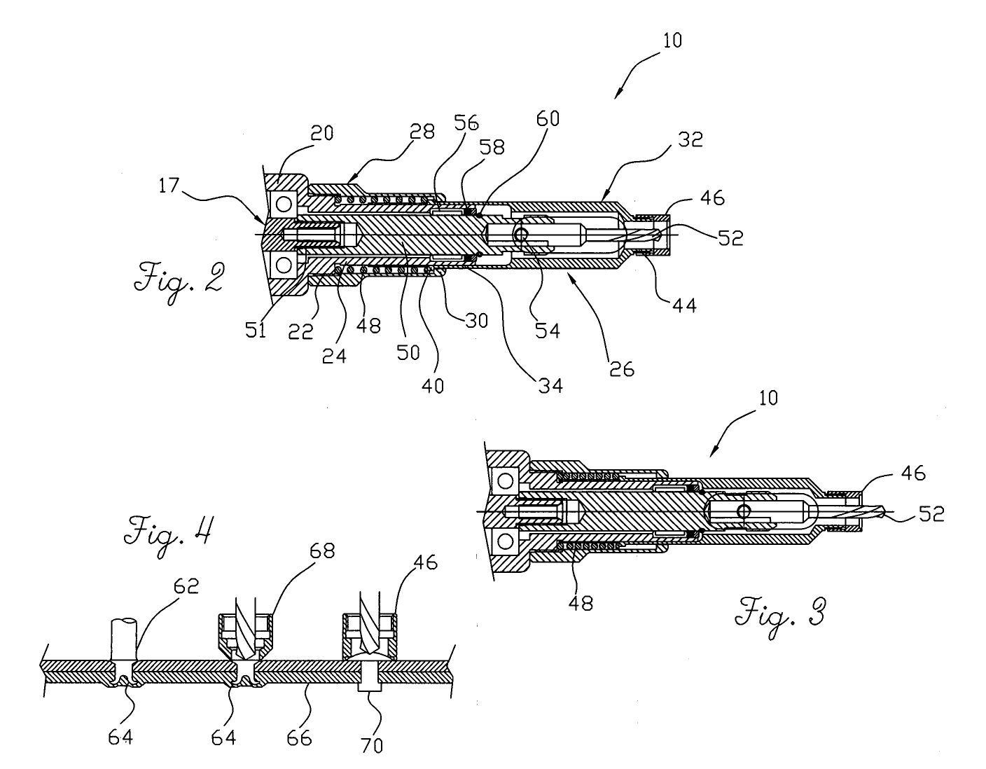

Referring now to the drawings and the characters of reference marked thereon, FIGS. 1-2 illustrate a preferred embodiment of the drill motor assembly of the present invention, designated generally as 10. The drill motor assembly 10 includes a drill assembly, designated generally as 12, that includes conventional drill components such as a motor (e.g. pneumatic, electric or hydraulic), connector 14 for connection to a power source, switching element (e.g. trigger 16), and motor output shaft 17. The drill assembly 12 includes a drill assembly housing 18 that includes a housing/guide support 20. The housing/guide support 20 and the motor output shaft 17 are each located at a distal end portion of the drill assembly housing 18. The housing/guide support 20 includes a threaded portion 22 and a guide portion 24 thereon.

The drill motor assembly 10 includes an attachment assembly, designated generally as 26. The attachment assembly 26 includes a retainer 28 having a proximal end secured to the threaded portion 22 of the housing/guide support 20. A securing lip 30 is located at a distal end of the retainer 28.

A guide element, designated generally as 32, of the drill motor assembly 10 includes a guide element proximal portion 34, a guide element distal portion 36, and a centering guide 46. The guide element proximal portion 34 is positioned about an outer surface of the housing/guide support 20 for slideable engagement thereto. The guide element proximal portion 34 includes a radially outward extending guide element stop 40. The guide element distal portion 36 includes an opening 42 for changing drill bits and for evacuation of rivet chips; and, a centering guide attachment portion 44 on the distal end thereof.

A centering guide 46 of the guide element 32 is attached to the centering guide attachment portion 44. The centering guide 46 has a tip for engagement on an outer circumferential edge of a rivet to be removed. As will be disclosed in more detail below, various centering guides 46 can be attached depending on the type of rivet to be removed.

The attachment assembly 26 includes a spring 48 positioned between the guide element proximal portion 34 and the retainer 28. The spring 48 urges the guide element stop 40 against the securing lip 30 of the retainer 28 for maintaining the centering guide 46 against a rivet to be removed.

A drill attachment shaft 50 of the attachment assembly 26 has a proximal end securely attached to the motor output shaft 17 (via threads 51) and a distal end for receiving and securely attaching a drill bit 52. A bearing 56 supports the drill attachment shaft relative to the housing/guide support 20. The bearing 56 is preferably a needle bearing; however, other suitable bearings may be utilized. An o-ring seal 58 and retaining ring 60 are provided for the needle bearing 56.

During use the centering guide 46 is positioned about the outer circumferential edge of a rivet so as to center an attached drill bit 52 relative to the rivet. The drill bit 52 may be secured into position by set screws 54. The guide element 32 is axially translatable relative to the housing/guide support 20. FIG. 3 shows the guide element 32 in the fully retracted position. The spring 48 is compressed. The drill bit 52 extends out of the centering guide 46. The drill motor assembly 10 operates in a range of about 500 to 4000 rpm depending on the material.

Referring now to FIG. 4, the left side of this figure shows a welded stud 62 on a countersunk self-piercing rivet 64 to be ripped out in the conventional manner. When ripping out in this fashion damage to the underlying material 66 may occur.

In accordance with the present invention, as shown in the center of FIG. 4, the countersunk self-piercing rivet 64 is shown being removed by the present invention 10. A centering guide 68 that is utilized for this type of rivet 64 cradles the rivet 64 in order to drill it in the center.

In the right side of FIG. 4, a dome type rivet 70 is shown being removed using a centering guide 46, such as shown in FIGS. 1-3. The drill guide 46 is guided to the center of the rivet.

The present technique is faster and less destructive than conventional techniques because with conventional techniques the surface of the rivet needs to be ground before welding the stud. Then, the stud is welded and it often breaks off. If this occurs it cannot be re-welded, then it needs to be drilled out in any event. Further, the equipment for welding the stud is expensive.

Other embodiments and configurations may be devised without departing from the spirit of the invention and the scope of the appended claims.

1. A drill motor assembly for drilling out rivets, comprising:
a) a drill assembly, comprising a drill assembly housing, including a housing/guide support, said drill assembly further including a motor output shaft, said housing/guide support and said motor output shaft each located at a distal end portion of said drill assembly housing, said housing/guide support including a threaded portion and a guide portion thereon;
b) an attachment assembly, comprising:
i. a retainer having a proximal end secured to said threaded portion of said housing/guide support and a securing lip at a distal end thereof;
ii. a guide element, comprising:
1. a guide element proximal portion positioned about an outer surface of said housing/guide support for slideable engagement thereto, said guide element proximal portion including a radially outward extending guide element stop;
2. a guide element distal portion, including:
a. an opening for changing drill bits and for evacuation of rivet chips; and,
b. a centering guide attachment portion on the distal end thereof; and,
3. a centering guide attachable to said centering guide attachment portion, said centering guide having a tip for engagement on an outer circumferential edge of a rivet to be removed;
iii. a spring positioned between said guide element proximal portion and said retainer, said spring for urging said guide element stop against said securing lip of said retainer;
iv. a drill attachment shaft having a proximal end securely attached to said motor output shaft and a distal end for receiving and securely attaching a drill bit; and,
v. a bearing for supporting said drill attachment shaft relative to said housing/guide support;
wherein during use said centering guide is positioned about the outer circumferential edge of a rivet so as to center an attached drill bit relative to the rivet, said guide element being axially translatable relative to said housing/guide support.

2. The drill motor assembly of claim 1, wherein said bearing comprises a needle bearing.

3. The drill motor assembly of claim 1, wherein said bearing comprises an o-ring seal.

4. The drill motor assembly of claim 1, wherein said drill motor assembly operates in a range of about 500 to 4000 rpm.

5. A drill motor assembly for drilling out rivets, comprising:
a) a drill assembly; and,
b) an attachment assembly including a centering guide positioned about the outer circumferential edge of a rivet so as to center an attached drill bit relative to the rivet, said guide element being axially translatable relative to a portion of said drill assembly to provide removal of the rivet.

6. The drill motor assembly of claim 1, wherein said drill assembly, comprises a drill assembly housing, including a housing/guide support, said drill assembly further including a motor output shaft, said housing/guide support and said motor output shaft each located at a distal end portion of said drill assembly housing, said housing/guide support including a threaded portion and a guide portion thereon.

7. The drill motor assembly of claim 6, wherein said attachment assembly, comprises:
i. a retainer having a proximal end secured to said threaded portion of said housing/guide support and a securing lip at a distal end thereof;
ii. a guide element, comprising:
1. a guide element proximal portion positioned about an outer surface of said housing/guide support for slideable engagement thereto, said guide element proximal portion including a radially outward extending guide element stop;
2. a guide element distal portion, including:
a. an opening for changing drill bits and for evacuation of rivet chips; and,
b. a centering guide attachment portion on the distal end thereof; and,
3. said centering guide attachable to said centering guide attachment portion, said centering guide having a tip for engagement on an outer circumferential edge of a rivet to be removed;
iii. a spring positioned between said guide element proximal portion and said retainer, said spring for urging said guide element stop against said securing lip of said retainer;
iv. a drill attachment shaft having a proximal end securely attached to said motor output shaft and a distal end for receiving and securely attaching a drill bit; and,
v. a bearing for supporting said drill attachment shaft relative to said housing/guide support;
wherein during use said centering guide is positioned about the outer circumferential edge of a rivet so as to center an attached drill bit relative to the rivet, said guide element being axially translatable relative to said housing/guide support.
